(19) United States
(12) Patent Application Publication
(10) Pub. No.: US 2013/0115543 A1
(43) Pub. Date: May 9, 2013

(54) THERMOSTABLE POLYMER ELECTROLYTE MEMBRANE AND PROCESS FOR PRODUCING THE SAME

(71) Applicants: Kazuaki Kudo, Tokyo (JP); Toshio Takayama, Tokyo (JP); June Park, Tokyo (JP); Masaharu Asano, Takasaki-shi (JP); Yasunari Maekawa, Takasaki-shi (JP)

(72) Inventors: Kazuaki Kudo, Tokyo (JP); Toshio Takayama, Tokyo (JP); June Park, Tokyo (JP); Masaharu Asano, Takasaki-shi (JP); Yasunari Maekawa, Takasaki-shi (JP)

(73) Assignees: JAPAN ATOMIC ENERGY AGENCY, Ibaraki (JP); THE UNIVERSITY OF TOKYO, Tokyo (JP)

(21) Appl. No.: 13/468,745

(22) Filed: May 10, 2012

(30) Foreign Application Priority Data
Nov. 9, 2011 (JP) 2011-245110

(51) Int. Cl. H01M 8/10

(52) U.S. Cl. 429/493

(57) ABSTRACT

The present invention relates to a thermostable polymer electrolyte membrane which comprises a main chain comprising an alicyclic polybenzimidazole and a graft chain added to the main chain by radiation-induced graft polymerization, wherein at least a part of the graft chain has sulfonic acid groups. The thermostable polymer electrolyte membrane of the invention is used for many apparatuses such as polymer electrolyte fuel cells or water electrolysis devices, in which the electrolyte membrane exhibits high proton conductivity, low fuel permeability, high oxidation resistance and superior mechanical property under operation conditions at high temperature. The present invention also provides a simple and low-cost process for producing the same.

### RELATED APPLICATIONS

This application claims priority to Japanese Patent Application No. 2011-245110 filed on Nov. 9, 2011, of which is incorporated herein by reference in its entirety.

### FIELD OF THE INVENTION

The present invention relates to a thermostable polymer electrolyte membrane suitable for a polymer electrolyte fuel cell, which comprises a main chain comprising an alicyclic polybenzimidazole and a graft chain added to the main chain by radiation-induced graft polymerization wherein at least a part of the graft chain has sulfonic acid groups, and a process for producing the same.

### DESCRIPTION OF THE RELATED ART

A fuel cell employing a polymer electrolyte membrane has a low operation temperature of 150° C. or below and high power generation efficiency and energy density, thus it is expected to be a power source for a mobile device utilizing methanol, hydrogen and the like as fuel, a cogeneration power source for domestic use, and a power source of a fuel cell vehicle. This fuel cell depends on important component technologies such as a polymer electrolyte membrane (PEM), an electrode catalyst, a gas diffusion electrode, and an assembly thereof as shown in FIG. 1. Among them, the development of polymer electrolyte membranes having superior characteristics as fuel cells is one of the most important technologies.

In a polymer electrolyte fuel cell, the polymer membrane acts as an electrolyte for conducting a hydrogen ion (proton) and further as a “separator” or “barrier membrane” for preventing methanol or hydrogen of fuel from being directly mixed with oxygen. This polymer electrolyte membrane is required to have high proton conductivity, to have superior chemical stability to resist the prolonged use, particularly superior resistance to hydroxyl radicals and the like which will be the main cause of the degradation of the membrane (oxidation resistance), to have prolonged thermostability at the operation temperature of the cell or higher than that, and to have a constant and high water uptakes of the membrane for holding the proton conductivity high. On the other hand, the polymer electrolyte membrane is required, because of the role as a separator, to have superior mechanical strength and dimensional stability and to have a low permeability of hydrogen, methanol and oxygen.

As an electrolyte membrane for a polymer electrolyte fuel cell, a polymer electrolyte membrane comprising fully-fluorinated polymeric sulfonic acid developed by Du Pont, “Nafion (a registered trademark of Du Pont)” etc has been commonly used. However, although a conventional fully-fluorinated polymer electrolyte membrane such as Nafion® has excellent chemical durability and stability, its water uptake property is insufficient at high temperature and low humidity, thereby resulting in the dryness of an ion exchange membrane and then the decrease of proton conductivity, or the swelling of the membrane and the crossover of methanol when methanol is used as fuel. Also, there was a drawback in that the mechanical characteristics significantly decrease under operation conditions of higher than 100° C. necessary for a power source of a motor vehicle. Further, a process for manufacturing a fully-fluorinated polymer electrolyte membrane, because of starting from the synthesis of fluorinated monomers, comprises many manufacturing steps, becomes complicated, and thus is costly, which has been a big obstacle to its practical use as a power source for a cogeneration system for domestic use and a power source of a fuel cell vehicle.

Therefore, the development of a low-cost polymer electrolyte membrane instead of the fully-fluorinated polymer electrolyte membrane above has been promoted actively. For example, producing partially-fluorinated polymer electrolyte membranes has been attempted by introducing a styrene monomer to a partially-fluorinated polymer base film such as polytetrafluoroethylene, polyvinylidene fluoride, and ethylene-tetrafluoroethylene copolymer by graft polymerization, and by subsequent sulfonation (for example, see Patent Literature 1). However, a fluorinated polymer base film had drawbacks in which the mechanical strength significantly decreases at high temperature of 100° C. or more due to its low glass transition temperature, falling off sulfonic acid groups introduced at a polystyrene graft chain is caused and then the proton conductivity of the electrolyte membrane substantially decreases if a large current flows in the electrolyte membrane for a prolonged time, and further the crossover of hydrogen and oxygen as fuel tends to occur.

Meanwhile, as a low-cost hydrocarbon polymer electrolyte membrane, an aromatic polymer electrolyte membrane has been proposed (for example, see Patent Literature 2). The aromatic polymer electrolyte membrane is expected for the use at high temperature since it has excellent mechanical strength at high temperature and a low permeability to fuels such as methanol, hydrogen, and oxygen. This aromatic polymer electrolyte membrane is produced by sulfonating an aromatic polymer compound represented by engineering plastics by dissolving it in a sulfonating solution such as a concentrated sulfuric acid and a chlorosulfonic acid, and by subsequent membrane preparation from the solution of the sulfonated aromatic polymer by a cast method (for example, see Patent Literature 3). This aromatic polymer electrolyte membrane may be obtained by a polymerization reaction of an aromatic monomer to which sulfonic acid groups has been coupled and by a subsequent membrane-formation (for example, see Patent Literature 4).

Furthermore, it has been reported that a grafted aromatic polymer electrolyte membrane can be produced by a chemical treatment after introducing a polymer graft chain including a precursor of a proton conducting group onto an aromatic base polymer membrane by radiation-induced graft polymerization. A process for producing a grafted aromatic polymer electrolyte membrane is disclosed, the process comprises steps of radiation-induced graft polymerization of a styrene sulfonic acid ethyl ester and a subsequent hydrolysis in the case of using polyetheretherketone (PEEK) as a base membrane, or radiation-induced graft polymerization of a styrene and a subsequent sulfonation in the case of using a polyimide (Kapton) as a base membrane (for example, see Patent Literatures 5, 6, and 7).

An aromatic polymer electrolyte membrane is expected to be used at high temperature because of having superior properties at high temperature. However, the processes of producing an aromatic polymer electrolyte membrane disclosed in Patent Literatures 3 and 4 need complicated steps such as the use of a large amount of dilution water for the deposition of sulfonated compounds because a large amount of a strong acid is used for dissolving aromatic polymer compounds. Also, the separation between a hydrophobic layer maintaining the mechanical strength and an electrolyte layer playing a role in proton conduction is not clear because sulfonic acid groups exist randomly in an aromatic polymer chain. Thus, the proton conductivity, low fuel permeability, and oxidation resistance are insufficient.

In view of compensating these drawbacks, a grafted aromatic polymer electrolyte membrane has been proposed as shown in Patent Literatures 5 to 7. However, a grafted aromatic polymer electrolyte membrane using PEEK as a base membrane exhibits significantly decreased mechanical strength and durability at higher temperature due to its fairly low glass transition temperature (140° C.). Also, a grafted aromatic polymer electrolyte membrane using a polyimide as a base membrane shown in Patent Literature 7 has a drawback in which the hydrolysis of an imide ring in high-temperature water causes significant degradation of the membrane.

All patents and publications identified herein are incorporated herein by reference in their entireties.

### PRIOR ART DOCUMENTS

### Patent Literatures

[Patent Literature 1] Japanese Laid-open Patent [Kokai] Publication No. 2001-348439
[Patent Literature 2] U.S. Pat. No. 5,403,675
[Patent Literature 3] Japanese Laid-open Patent [Kohyo] Publication No. Hei 11-502245
[Patent Literature 4] Japanese Laid-open Patent [Kokai] Publication No. 2004-288497
[Patent Literature 5] Japanese Laid-open Patent [Kokai] Publication No. 2008-53041
[Patent Literature 6] Japanese Laid-open Patent [Kokai] Publication No. 2008-195748
[Patent Literature 7] Japanese Laid-open Patent [Kokai] Publication No. 2010-92787

### SUMMARY OF THE INVENTION

According to the analysis by the present inventors, an aromatic polybenzimidazole base film having higher thermostability than that of polyimide has also high stability to radiations. When the base polymers were irradiated to generate a radical as a graft active site, sufficient radicals were not generated for subsequently grafting a monomer by graft polymerization, so that it was difficult to introduce a graft chain necessary for an electrolyte membrane. Therefore, it was a problem to obtain an aromatic polybenzimidazole base film that has higher proton conductivity essentially required for an electrolyte membrane.

In order to solve the problems described above and to enhance the mechanical properties and durability of a membrane at high temperature, the present invention is directed to permit radiation-induced graft polymerization to a main chain polymer comprising an aromatic polybenzimidazole, which was difficult in conventional methods, by introducing an alicyclic hydrocarbon group along with using a polybenzimidazole to a base of a polymer electrolyte membrane. And, it has been found that the introduction of sulfonic acid groups to a graft chain of such alicyclic polybenzimidazole base film provides a thermostable polymer electrolyte membrane superior in proton conductivity, low fuel permeability, mechanical properties, oxidation resistance and durability against hot water to conventional aromatic polymer electrolyte membranes and grafted aromatic polymer electrolyte membranes.

Accordingly, in a first aspect of the present invention, there is provided a thermostable polymer electrolyte membrane which comprises a main chain comprising an alicyclic polybenzimidazole and a graft chain added to the main chain by radiation-induced graft polymerization, wherein at least a part (portion) of the graft chain has sulfonic acid groups.

In a preferred embodiment of the present invention, the alicyclic polybenzimidazole is represented by the following formula (I):

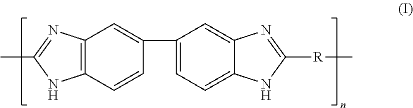

wherein R is C₃₋₂₀ cycloalkylene or C₇₋₁₄ spiroalkylene and n is an integer from 20 to 1000. The graft chain is prepared by radiation-induced graft polymerization of a monomer selected from the group consisting of aromatic vinyl compounds, acrylic acid or derivatives thereof, acrylamide derivatives, vinylketones, acrylonitriles and fluorinated vinyl compounds onto the main chain.

In a further preferred embodiment, the monomer additionally comprises a polyfunctional monomer in an amount of 10% or less by weight on the basis of total monomer weight, wherein the polyfunctional monomer is selected from the group consisting of bis(vinylphenyl)ethane, divinylbenzene, 2,4,6-triallyloxy-1,3,5-triazine (triallyl cyanurate), triallyl-1,2,4-benzenetricarboxylate, diallylether, bis(vinylphenyl)methane, divinylether, 1,5-hexadiene, and butadiene.

In another aspect of the present invention, there is provided a process for producing a thermostable polymer electrolyte membrane which comprises the steps of irradiating ionizing radiations to a base polymer comprising an alicyclic polybenzimidazole, contacting the irradiated base polymer with one or more monomers to graft the monomers by radiation-induced graft polymerization, and sulfonating the graft chain introduced by the radiation-induced graft polymerization.

Preferably, the alicyclic polybenzimidazole is represented by the following formula (I):

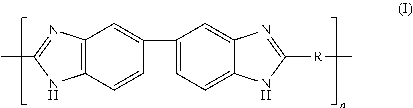

wherein R is C₃₋₂₀ cycloalkylene or C₇₋₁₄ spiroalkylene and n is an integer from 20 to 1000, and the monomer is a vinyl monomer selected from the group consisting of aromatic vinyl compounds, acrylic acid or derivatives thereof, acrylamide derivatives, vinylketones, acrylonitriles, and fluorinated vinyl compounds.

In a further preferred embodiment of the present invention, the production process further comprises the steps of, for the preparation of the base polymer, preparing a lyotropic liquid crystalline solution comprising alicyclic polybenzimidazole and lithium chloride, and casting and drying the solution to a thin layer film.

In a further different aspect of the present invention, a thermostable polymer electrolyte membrane produced by the methods above and having an ion exchange capacity (IEC) from 0.5 to 3.3 mmol/g and durability of 90% or more against hot water after incubation at 120° C. for 4 hours and a fuel cell comprising such thermostable polymer electrolyte membrane are provided.

A thermostable polymer electrolyte membrane of the present invention is basically stable under operation conditions at high temperature because of using an alicyclic polybenzimidazole base film having high thermostability and can have characteristics such as high proton conductivity, low fuel permeability, high oxidation resistance, and superior mechanical properties. Also, the cross-linking effect between graft chains and/or between a graft chain and a polymer chain is further enhanced by grafting a monomer and a polyfunctional monomer onto the alicyclic polybenzimidazole base film. Further, since an electrolyte layer of micro/nano regions can be intentionally formed by sulfonation of an aromatic ring in the graft chain, the separation between a hydrophobic layer maintaining the mechanical strength and an electrolyte layer playing a role in proton conduction is clearer. Thus, the thermostable polymer electrolyte membrane with both high proton conductivity and superior mechanical strength can be obtained.

Meanwhile, a process for producing a thermostable polymer electrolyte membrane of the present invention is eco-friendly and can reduce production costs significantly because the process does not need conventional steps of dissolution and dilution into a sulfonating solution and the sulfonating solution can be used repeatedly. Further, the thermostable polymer electrolyte membrane produced by the process of the present invention can have more superior mechanical strength because multiple cross-linkages are imparted by treatment at high temperature and thereby introducing a crosslink between a part of sulfonic acid groups.

### BRIEF DESCRIPTION OF THE DRAWINGS

FIG. 1 shows a schematic diagram of a typical fuel cell relating to the present invention.

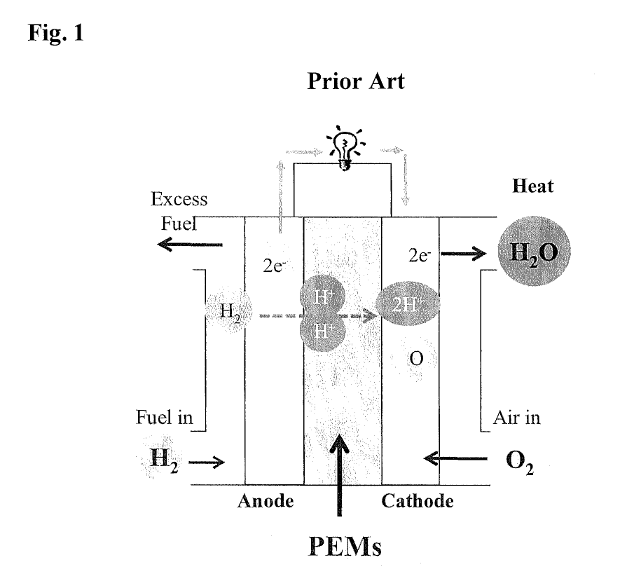

FIG. 2A shows the X-ray diffraction (XRD) data of a film produced by using an alicyclic polybenzimidazole of the present invention and FIG. 2B shows the result from examining the generation of radicals when irradiating 220 kGy of radiations (gamma radiations) to the alicyclic polybenzimidazole film produced by the process of the present invention.

### DESCRIPTION OF THE PREFERRED EMBODIMENTS

### Definitions

Unless otherwise stated, the following terms used in this application, including the specification and claims, have the definitions given below. It must be noted that, as used in the specification and the appended claims, the singular form “a”, “an” and “the” include plural referents unless the context clearly dictates otherwise. Thus, the phrase “a” or “an” entity as used herein refers to one or more of that entity, for example, a compound refers to one or more compounds or at least one compound. As such, the terms “a” (or “an”), “one or more” and “at least one” can be used interchangeably herein.

The term “alicyclic” means a moiety comprising a non-aromatic ring structure. Alicyclic moieties may be saturated or partially unsaturated with one, two or more double or triple bonds. The term “alicyclic moiety” may also be referred to as “cyclic aliphatic moiety” and includes both monocyclic and spirocyclic structures. The main chain of the cyclic hydrocarbon moiety may, unless otherwise stated, be of any length and contain any number of non-aromatic cyclic and chain elements. Typically, the hydrocarbon (main) chain includes 3, 4, 5, 6, 7 or 8 main chain atoms in one cycle. Examples of such moieties include, but are not limited to, cyclopentyl, cyclohexyl, cycloheptyl, or cyclooctyl. Thus, the term “alicyclic benzimidazole” means a moiety comprising at least an “alicyclic moiety” and a “benzimidazole group”.

A thermostable polymer electrolyte membrane of the present invention comprises a main chain comprising an alicyclic polybenzimidazole and a graft chain added to the main chain preferably by radiation-induced graft polymerization. The structure of the main chain is not particularly limited as long as the membrane shape can be maintained in a reaction solution in a graft polymerization step and a sulfonation step and the resulting polymer electrolyte membrane comprises an alicyclic polybenzimidazole having high mechanical properties. Such alicyclic polybenzimidazole is commercially available or can be prepared by those skilled in the art in accordance with methods described in chemical literatures. For example, the alicyclic polybenzimidazole can be obtained by heating aromatic tetraamines such as 3,3′-diaminobenzidine tetrahydrochloride hydrate and dicarboxylic acid of alicyclic hydrocarbon compounds such as cyclohexanedicarboxylic acid in polyphosphoric acid in accordance with methods described in Inoue Y. et al., Die Makromolekulare Chemie 95 (1966) 236-247.

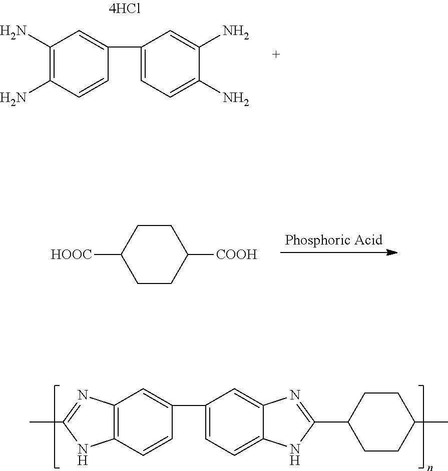

Other examples of aromatic tetraamines include 3,3′,4,4′-tetraminobiphenyl; 1,2,4,5-tetraminobenzene; 1,2,5,6-tetraminonaphthalene; 2,3,6,7-tetraminonaphthalene; 3,3′,4,4′-tetraminodiphenylmethane; 3,3′,4,4′-tetraminodiphenylethane; 3,3′,4,4′-tetraminodiphenyl-2,2-propane; 3,3′,4,4′-tetraminodiphenylthioether; 3,3′,4,4′-tetraminodiphenylsulfone; and the like. A preferred aromatic tetraamine is 3,3′,4,4′-tetraminobiphenyl.

Alternatively, the aromatic tetraamine may have a structure below:

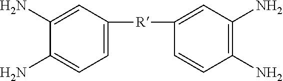

wherein R′ is a divalent radical represented by —O—, —C(═O)—, —C(CH₃)₂—, —S(═O)₂—, or a phenylene group.

Examples of dicarboxylic acids of alicyclic hydrocarbon compounds include dicarboxylic acids of C₃₋₂₀ cycloalkylene, C₇₋₁₄ spiroalkylene or the like. An alicyclic polybenzimidazole constituting a main chain thereof can be modified accordance with known methods in the art, so that yet another alicyclic polybenzimidazole is produced.

In a preferred embodiment of the present invention, the alicyclic polybenzimidazole can be represented by formula (I):

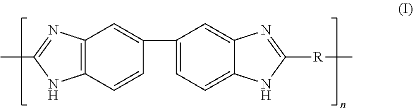

wherein R is C₃₋₂₀ cycloalkylene or C₇₋₁₄ spiroalkylene and n is an integer from 20 to 1000, preferably from 200 to 800.

C₃₋₂₀ cycloalkylene includes monocycloalkylene such as cyclopropylene, cyclopentylene and cyclohexylene; bicycloalkylene such as bicyclo[2.2.1]pentylene (norbornylene), 1,7,7-trimethylbicyclo[2.2.1]heptylene (isobornylene) and bicyclo[2.2.2]octylene; and tricycloalkylene such as tricyclo[5.2.1.0^{2,6}]decanylene and tricyclo[3.3.1.1^{3,7}]decanylene (adamantylene), and tetracycloalkylene such as tetracyclo[6.2.1.1^{3,6},0^{2,7}]decanylene. C₇₋₁₄ spiroalkylene includes spiro[3,3]heptylene, spiro[2,4]heptylene, spiro[2,5]octylene, spiro[3,4]octylene, spiro[2,6]nonanylene, spiro[3,5]nonanylene, spiro[4,4]nonanylene, spiro[4,5]decanylene, spiro[5,5]undecanylene, spiro[5,6]dodecanylene, and the like. If these cycloalkylenes and spiroalkylenes include cis or trans isomers or optical isomers, any of the isomers or mixture thereof may be used.

In a preferred embodiment, C₃₋₂₀ cycloalkylene above is 1,4-cyclohexylene, norbornylene, dinorbornylene, adamantylene, diadamantylene, and bicyclo[2.2.2]octylene, and C₇₋₁₄ spiroalkylene is preferably spiro[3,3]heptylene. A polymer of formula (I) above wherein R is cyclohexylene, may be referred to as “A-PBI” hereinafter.

In the present invention, a monomer which is grafted onto an alicyclic polybenzimidazole base film by graft polymerization includes aromatic vinyl compounds such as styrene, acrylic acid or derivatives thereof, acrylamides, vinylketones, acrylonitriles, fluorinated vinyl compounds, polyfunctional monomers or the like so that a graft chain in the resulting graft alicyclic polybenzimidazole film can be sulfonated and the graft chains can be crosslinked one another by irradiating ionizing radiations.

The aromatic vinyl compounds such as styrene are represented by formula (II):

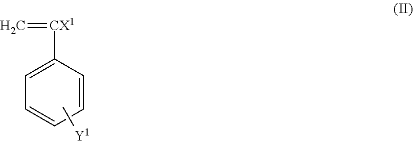

wherein X¹ denotes —H, —CH₃, —CH₂CH₃, —OH, —Cl, —F, —Br, or —I and Y¹ includes —H, —CH₃, —CH₂CH₃, —CH₂CH₂CH₃, —C(CH₃)₃, —OCH₃, —OCH₂CH₃, —OCH₂CH₂CH₃, —OC(CH₃)₃, —CH₂Cl, —CN, —SO₃CH₃, —Si(OCH₃)₃, —Si(OCH₂CH₃)₃, —CH═CH₂, —OCH═CH₂, —OH, —Cl, —F, —Br, and the like. The formula (II) shows that substituent Y¹ may be attached to the vinyl group in any of meta, para, and ortho positions.

The acrylic acid or derivatives thereof above are represented by formula (III):

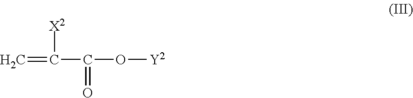

wherein X² denotes —H, —CH₃, —CH₂CH₃, —OH, —Cl, —F, —Br, or —I and Y² includes —H, —CH₃, —CH₂CH₃, —CH₂CH₂CH₃, —C(CH₃)₃, —CH₂Cl, —Si(OCH₃)₃, —Si(OCH₂CH₃)₃, a benzene ring, and like.

The acrylamides above are represented by formula (IV):

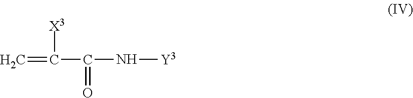

wherein X³ denotes —H, —CH₃, —CH₂CH₃, —OH, —Cl, —F, —Br, or —I and Y³ includes —H, —CH₃, —CH₂CH₃, —CH₂CH₂CH₃, —C(CH₃)₃, —CH₂Cl, a benzene ring, and like.

The vinylketones above are represented by formula (V):

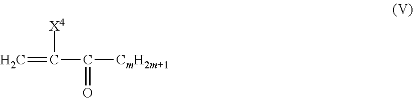

wherein X⁴ denotes —H, —CH₃, —CH₂CH₃, —OH, —Cl, —F, —Br, or —I and m is an integer from 1 to 5.

The nitriles include acrylonitrile (CH₂═CHCN), methacrylonitrile (CH₂═C(CH₃)CN), and the like.

Also, the fluorinated vinyl compounds include CF₂═CF—C₆H₅, CF₂═CF—O—(CF₂)ₘ—SO₂F, CF₂═CF—O—CF₂—CF(CF₃)—O—(CF₂)ₘ—SO₂F, CF₂═CF—SO₂F, CF₂═CF—O—(CH₂)ₘ—X, CH₂═CH—O—(CF₂)ₘ—X, CF₂═CF—O—(CF₂)ₘ—X, CF₂═CF—O—CF₂—CF(CF₃)—O—(CF₂)ₘ—X, CF₂═CF—O—(CH₂)ₘ—CH₃, CH₂═CH—O—(CF₂)ₘ—CF₃, CF₂═CF—O—(CF₂)ₘ—CF₃, CF₂═CF—O—CF₂—CF(CF₃)—O—(CF₂)ₘ—CF₃, and the like, wherein m is independently an integer from 1 to 5 at each occurrence and X is a halogen atom, preferably chlorine or fluorine.

The structures of the polyfunctional monomers above are not particularly limited as long as they can impart cross-linkages to graft chains by a grafting reaction. The polyfunctional monomers include bis(vinylphenyl)ethane, divinylbenzene, 2,4,6-triallyloxy-1,3,5-triazine (triallylcyanurate), triallyl-1,2,4-benzenetricarboxylate (triallyltrimellitate), diallylether, bis(vinylphenyl)methane, divinylether, 1,5-hexadiene, butadiene, and the like. The graft polymerization of the polyfunctional monomers can impart cross-linkages between graft chains. Preferably, the polyfunctional monomers are used at a combination ratio of 10% or less by weight on the basis of total monomer weight. If the polyfunctional monomers are used at the ratio of greater than 10%, the polymer electrolyte membrane will be brittle.

In a different aspect of the present invention, a process for producing the thermostable polymer electrolyte membrane above comprises a step of irradiating ionizing radiations to a base polymer comprising an alicyclic polybenzimidazole, a step of contacting the irradiated base polymer with one or more monomers to graft the monomers by radiation-induced graft polymerization, and a step of sulfonating the graft chain introduced by the radiation-induced graft polymerization.

Firstly, an alicyclic polybenzimidazole used in a process of the present invention can be obtained in accordance with the above-mentioned methods and is commonly powder having a molecular weight of about 1.6×10⁵ Da and the melting point (Td) of 500° C. or more. The measurement of the molecular weight can be performed by using conventional methods such as GPC. This is used to prepare a film-shaped base polymer. In a preferred embodiment, a base polymer used for the present invention is a film obtained by casting and drying a lyotropic liquid crystalline solution comprising the alicyclic polybenzimidazole and lithium chloride to a thin layer.

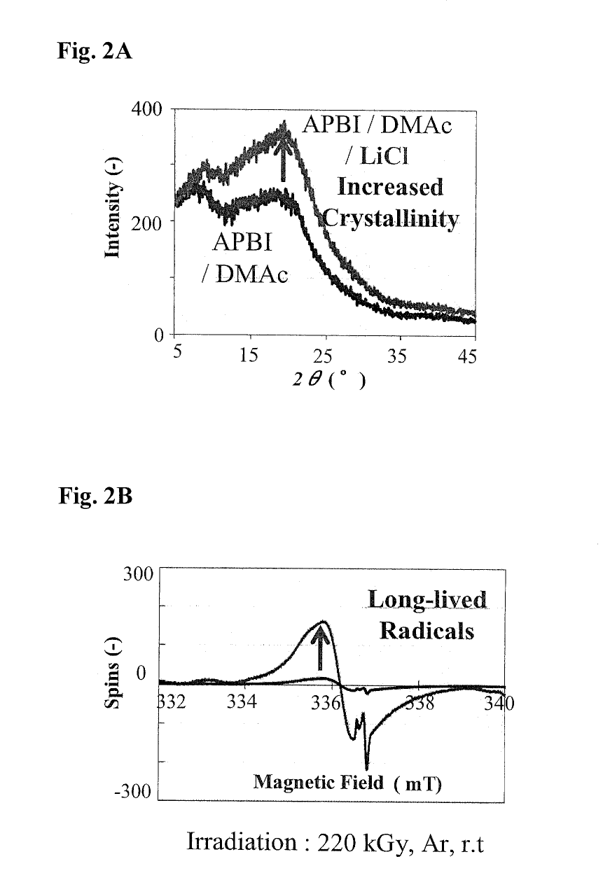

The alicyclic polybenzimidazole film thus produced has higher crystallinity than that of films produced by conventional methods as shown FIG. 2A. Since this makes the lifespan of radiation-generated radicals longer, this is desirable for increasing the grafting degree. FIG. 2A shows the result from examining the crystallinity degree of the membranes by XRD with or without the addition of LiCl (lithium chloride) in the membrane-formation by dissolving the powder of alicyclic polybenzimidazole in a DMAc (dimethylacetamide) solvent. As shown in FIG. 2A, it is understood that the membrane crystallinity is higher in the case of the addition of LiCl. FIG. 2B shows the result from measuring radicals generated by irradiating 220 kGy of gamma radiations to the membranes thus produced. It is understood that the use of a membrane with higher crystallinity allows the longer lifespan of radicals generated and thus such membrane is preferred for radiation-induced graft polymerization reaction.

Preferably, in the process according to the invention, a radiation-induced graft polymerization is performed by irradiating 5-1000 kGy of radiations to a base polymer at a temperature from room temperature (about 20° C.) to 150° C. in the presence of an inert gas such as argon or in the presence of oxygen. In the case of less than 5 kGy, it is difficult to obtain the grafting degree needed to obtain electrical conductivity of 0.02([Ω·cm]⁻¹) or more required as a fuel cell. In the case of greater than 1000 kGy, the polymer membrane base will be fragile. Radiation-induced graft polymerization is performed by “simultaneous irradiation method” in which a graft polymerization is carried out by irradiating radiations to a base polymer and monomer derivatives simultaneously, or “pre-irradiation method” in which a graft polymerization is carried out by irradiating radiations to a base polymer previously and then contacting it with monomer derivatives. The pre-irradiation method is preferred because a smaller amount of homopolymer is produced. The pre-irradiation method includes “polymer radical method” in which a base polymer is irradiated in an inert gas and “peroxide method” in which a base polymer is irradiated in the presence of oxygen, either of which is applicable.

Radiation-induced graft polymerization of a base polymer is performed by immersing the base polymer in a monomer liquid. It is preferred to use a method of immersing a base polymer in a monomer solution diluted with a solvent such as dichloroethane, chloroform, N-methyl formamide, N-methyl acetamide, N-methylpyrrolidon, gamma-butyrolactone, n-hexane, methanol, ethanol, 1-propanol, t-butanol, toluene, cyclohexane, cyclohexanone, and dimethyl sulfoxide, in terms of the graft polymerization property of the base polymer and the maintenance of the membrane shape of the grafted base polymer obtained by the graft polymerization in a polymerization solution.

In the present invention, the graft polymerization of monomers onto an alicyclic polybenzimidazole base film is performed by utilizing a graft active site such as a radical generated on the alicyclic polybenzimidazole base film by ionizing radiations. The properties of the electrolyte membrane are varied by controlling a grafting degree. A preferred grafting degree is 5-150% by weight relative to the alicyclic polybenzimidazole base film. A more preferred grafting degree is 30-120% by weight. In the case of greater than 150% by weight, mechanical strength suitable for a fuel cell with a graft alicyclic polybenzimidazole base film can not be obtained.

In the present invention, since an alicyclic polybenzimidazole base film or a monomer-grafted alicyclic polybenzimidazole base film can be dissolved in a highly-concentrated sulfonating solution, a sulfonation step is desired to include immersing the base film in a low-concentration sulfonating solution and treating it at low temperature. In a preferred sulfonation condition, a sulfonating solution comprises a sulfonating agent of 0.005-0.1 mol/L at a temperature of 10° C. or below. More preferably, the sulfonating solution comprises a sulfonating agent of 0.01-0.05 mol/L at a low temperature of −10° C. to 4° C., more preferably −5° C. to 0° C. The sulfonating agent is not particularly limited, but preferably, a chlorosulfonic acid can be used. As a solvent, dichloroethane and the like can be used. As a result, an alicyclic polybenzimidazole base film can be subjected to a sulfonation reaction with its shape being held, thus a thermostable polymer electrolyte membrane having superior performance which is applied to a fuel cell can be obtained directly from the alicyclic polybenzimidazole base film. Also, because the sulfonating solution can be used repeatedly, it is possible to treat a plurality of base films continuously.

The polymer electrolyte membrane functions by proton dissociation of sulfonic acid groups introduced into the base film by sulfonation. An amount of the sulfonic acid group is defined as an ion exchange capacity (the unit is mmol/g) which is the number of millimoles of sulfonic acid groups in 1 g of a dry electrolyte membrane. The ion exchange capacity of a polymer electrolyte membrane can be controlled by sulfonation conditions (sulfonating agents, solvent types, time of sulfonation, and temperatures) and a grafting degree of a graft polymer membrane. Preferably, the ion exchange capacity is adjusted in the range of from 0.5 to 3.3 mmol/g, more preferably from 1.0 to 3.0 mmol/g to produce a thermostable polymer electrolyte membrane exhibiting low water uptake and high proton conductivity. In the case of less than 0.5 mmol/g, it is difficult to obtain practical proton conductivity. In the case of greater than 3.3 mmol/g, the water uptake will increase and the mechanical strength will significantly decrease.

Because further cross-linkages can be introduced on the graft chains by heat-treating a thermostable polymer electrolyte membrane after sulfonation, the mechanical strength and thermostability are enhanced. Preferably, the heat-treatment is carried out at room temperature to 300° C. for 0 to 24 hours for efficiently introducing thermal cross-linkages represented by formula (VI) below. Since thermal crosslinking reaction proceeds efficiently in the range of from the glass temperature (Tg) of the aromatic polymer base film to Tg+50° C., more preferably, the heat-treatment is performed at 120 to 250° C. for 1 to 12 hours under vacuum.

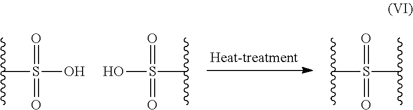 [SMILES: *S(=O)(=O)O ; *S(=O)(=O)O ; *S(*)(=O)=O]

In the present invention, it is conceivable that a polymer electrolyte membrane for a fuel cell is made thin for lowering the resistance of the polymer electrolyte membrane. However, under present circumstances, excessively thin polymer electrolyte membranes are fragile, thus it is difficult to manufacture membranes themselves. Therefore, in the present invention, the thermostable polymer electrolyte membrane of 15 to 200 μm is preferred. The thermostable polymer electrolyte membrane within the range of from 20 to 100 μm is more preferred.

In a further embodiment of the present invention, the thermostable polymer electrolyte membrane may be produced by radiation polymerization and sulfonation following a process of the present invention using a base polymer prepared by blending or copolymerizing the alicyclic polybenzimidazole according to the present invention (for example, A-PBI) and an aromatic polybenzimidazole not containing an alicyclic hydrocarbon (PBI) (collectively referred to as a blend membrane hereinafter). As PBI, instead of the alicyclic hydrocarbon (for example, R group in formula (I)), a phenyl group or two phenyl groups cross-linked by an oxygen atom, a sulfone group, a hexafluoroisopropylidene group or the like can be used. The blend electrolyte membrane thus produced is also within the scope of the present invention and exhibits high proton conductivity and higher mechanical strength.

### EXAMPLE

While examples and comparative examples describe the present invention below, the invention is not limited thereto. Each measured value was determined by the following methods of measurement and showed in Table 1.

### (1) Grafting Degree (%)

Taking a polymer membrane base as a main chain part and a graft polymerization part with a monomer as a graft chain part, the weight ratio of the graft chain part to the main chain part is expressed as the grafting degree (Grafting [% by weight]) of the following equation.

Grafting degree (Grafting)=100×(W_{g}−W₀)/W₀

W₀: weight in the dry state before grafting (g)

W_{g}: weight in the dry state after grafting (g)

(2) Ion Exchange Capacity (mmol/g)

An ion exchange capacity (IEC) of a polymer electrolyte membrane is expressed by the following equation.

IEC=n/Wₘ

n: an amount of sulfonic acid group of a polymer electrolyte membrane (mmol)

Wₘ: dry weight of a polymer electrolyte membrane (g)

In the measurement of n, a polymer electrolyte membrane is immersed in a 1M hydrochloric acid solution at 50° C. for four hours and made into the proton type (H type) completely. Then, it is washed with deionized water until pH=6 to 7 and a free acid is removed completely. Then, the ion exchange is performed by immersing the membrane in a saturated aqueous NaCl solution for 24 hours, thereby protons H⁺ are liberated. Subsequently, by neutralization titration of the electrolyte membrane and the aqueous solution with 0.02M NaOH, the amount of sulfonic acid group of the polymer electrolyte membrane was determined as an amount of proton W.

n=0.02 V (V: volume of 0.02M NaOH titrated (ml)).

### (3) Water Uptake (%)

An H type polymer electrolyte membrane stored in water at 80° C. for 24 hours was withdrawn, namely, water on the surface was lightly wiped up, and then the weight of water uptake W_{w} was measured. By weight measurement after vacuum-drying this membrane at 60° C. for 16 hours, the dry weight W_{d} of the polymer electrolyte membrane was determined. Water uptake was calculated from W_{w} and W_{d} according to the following equation.

Water uptake=100(W_{w}−W_{d})/W_{d}

### (4) Proton Conductivity (S/cm)

An H type polymer electrolyte membrane stored in water at room temperature was withdrawn, namely, it was inserted between both platinum electrodes, and then membrane resistance due to impedance was measured. The degree of proton conductivity of the polymer electrolyte membrane was calculated using the following equation.

κ=d/(Rm·S)

κ: degree of proton conductivity of a polymer electrolyte membrane (S/cm)
d: distance between both platinum electrodes (cm)
Rm: resistance of a polymer electrolyte membrane (Ω)
S: cross-sectional area of a flow of electricity through a polymer electrolyte membrane in resistance measurement (cm²)

### (5) Durability Against Hot Water (Holding Ratio of Degree of Proton Conductivity %)

The degree of proton conductivity of a polymer electrolyte membrane after immersed in water at room temperature is taken as σ₁ and the degree of proton conductivity of a polymer electrolyte membrane after immersed in hot water at 120° C. is taken as σ₂. Durability of the polymer electrolyte membrane against hot water was calculated using the following equation.

Durability against hot water=100(σ₂/σ₁)

### Example 1

A 2 cm×3 cm base film (25 μm in thickness) consisting of a cis-form cyclohexane-introduced alicyclic polybenzimidazole (abbreviated as A-PBI hereinafter) prepared by a method analogous to that described in Inoue Y. et al., Die Makromolekulare Chemie 95 (1966) 236-247 was placed in a glass separable vessel with a cock and degassed, and then the replacement with argon gas was conducted in the glass vessel. In this state, the A-PBI base film was irradiated with 220 kGy of gamma-radiations from the ⁶⁰Co source at room temperature. Subsequently, 50 ml of 1-propanol solution and 50 ml of styrene degassed by argon gas bubbling were added into this glass vessel so that the A-PBI base film irradiated was immersed. After the replacement with argon gas, the glass vessel was sealed and allowed to stand at 80° C. for 24 hours. The resulting graft polymer base film was washed with toluene. The grafting degree was calculated from the weight of the base film after dried. Next, the graft membrane was treated with a 0.05M chlorosulfonic acid/dichloroethane solution at 0° C. to afford an electrolyte membrane. The grafting degree, ion exchange capacity, water uptake, degree of proton conductivity, and durability of this thermostable polymer electrolyte membrane against hot water are shown in Table 1.

### Example 2

A thermostable polymer electrolyte membrane was obtained following an analogous procedure to that of Example 1 introducing 2% by weight of divinylbenzene of a polyfunctional vinyl monomer into a 1-propanol solution 50 ml of styrene 50 ml (1/1 vol %). The grafting degree, ion exchange capacity, water uptake, degree of proton conductivity, and durability of the thermostable polymer electrolyte membrane against hot water obtained in this Example are shown in Table 1.

### Example 3

The thermostable polymer electrolyte membrane obtained following an analogous procedure to that of Example 2 was further heat-treated at 180° C. for two hours under vacuum to react a part of sulfonic acid groups. Thus, a multiple cross-linkage thermostable electrolyte membrane having sulfone group cross-linkages was obtained. The grafting degree, ion exchange capacity, water uptake, degree of proton conductivity, and durability of the thermostable polymer electrolyte membrane against hot water obtained in this Example are shown in Table 1.

### Comparative Example 1

A 2 cm×3 cm aromatic polybenzimidazole base film (25 μm) was treated under the same radiation-induced graft polymerization conditions as those of Example 1. The resulting grafting degree was extremely low. The grafting degree, ion exchange capacity, water uptake, degree of proton conductivity, and durability of the thermostable polymer electrolyte membrane against hot water obtained in this Comparative Example are shown in Table 1.

### Comparative Example 2

A 2 cm×3 cm alicyclic polyimide base film (25 μm) was treated under the same radiation-induced graft polymerization conditions as those of Example 1. Then, an electrolyte membrane was obtained following an analogous procedure. The grafting degree, ion exchange capacity, water uptake, degree of proton conductivity, and durability of the thermostable polymer electrolyte membrane against hot water obtained in this Comparative Example are shown in Table 1.

### Comparative Example 3

A 2 cm×3 cm polyetheretherketone (PEEK) base film (25 μm) was treated under the same radiation-induced graft polymerization conditions as those of Example 1. Then, an electrolyte membrane was obtained following an analogous procedure. The grafting degree, ion exchange capacity, water uptake, degree of proton conductivity, and durability of the thermostable polymer electrolyte membrane against hot water obtained in this Comparative Example are shown in Table 1.

TABLE 1
Properties of polymer electrolyte membranes

| | Grafting | Ion Exchange | Water | Degree of Proton | Durability against | | |
|---|---|---|---|---|---|---|---|
| | Degree | Capacity | Uptake | Conductivity | hot water (%) | | |
| | (%) | (mmol/g) | (%) | (S/cm) | 1 h | 2 h | 4 h |
| Example 1 | 100 | 2.9 | 98 | 0.08 | 100 | 100 | 98 |
| Example 2 | 100 | 2.9 | 75 | 0.07 | 100 | 100 | 100 |
| Example 3 | 100 | 2.9 | 62 | 0.05 | 100 | 100 | 100 |
| Comparative | 0 | — | — | — | — | — | — |
| Example 1 | | | | | | | |
| Comparative | 60 | 1.9 | 43 | 0.06 | 54 | 20 | 0 |
| Example 2 | | | | | | | |
| Comparative | 80 | 2.5 | 60 | 0.06 | 91 | 83 | 74 |
| Example 3 | | | | | | | |
| Nafion ® | — | 0.9 | 30 | 0.06 | 88 | 71 | 46 |

A thermostable polymer electrolyte membrane of the present invention has high proton conductivity, low fuel permeability, high oxidation resistance, superior mechanical properties under operation conditions at high temperature. A process for producing this electrolyte membrane can reduce production costs significantly compared to conventional processes comprising complicated treatments of wasted acid and membrane formation steps because various monomers can be grafted onto an alicyclic polybenzimidazole base film. Also, it is expected to provide a polymer electrolyte membrane most suitable for a fuel cell for a mobile device utilizing methanol, hydrogen and the like as fuel, a cogeneration system for domestic use, and a motor vehicle because a micro-phase-separated structure of the polymer electrolyte membrane can be designed by controlling a sulfonation rate and grafting degree. That provides a great economic effect.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A thermostable polymer electrolyte membrane which comprises a main chain comprising an alicyclic polybenzimidazole and a graft chain added to the main chain by radiation-induced graft polymerization, wherein at least a part of the graft chain has sulfonic acid groups.

2. The thermostable polymer electrolyte membrane of claim 1, wherein the alicyclic polybenzimidazole is represented by the following formula (I): 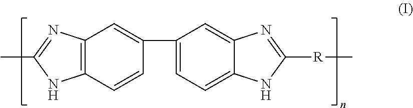
wherein R is C₃₋₂₀ cycloalkylene or C₇₋₁₄ spiroalkylene, and n is an integer from 20 to 1000.

3. The thermostable polymer electrolyte membrane of claim 1, wherein the graft chain is prepared by radiation-induced graft-polymerization of a monomer selected from the group consisting of aromatic vinyl compounds, acrylic acid or derivatives thereof, acrylamide derivatives, vinylketones, acrylonitriles and fluorinated vinyl compounds onto the main chain.

4. The thermostable polymer electrolyte membrane of claim 2, wherein the graft chain is prepared by radiation-induced graft-polymerization of a monomer selected from the group consisting of aromatic vinyl compounds, acrylic acid or derivatives thereof, acrylamide derivatives, vinylketones, acrylonitriles and fluorinated vinyl compounds onto the main chain.

5. The thermostable polymer electrolyte membrane of claim 3, wherein the monomer additionally comprises a polyfunctional monomer in an amount of 10% or less by weight on the basis of total monomer weight, wherein the polyfunctional monomer is selected from the group consisting of bis(vinylphenyl)ethane, divinylbenzene, 2,4,6-triallyloxy-1,3,5-triazine (triallyl cyanurate), triallyl-1,2,4-benzenetricarboxylate, diallylether, bis(vinylphenyl)methane, divinylether, 1,5-hexadiene and butadiene.

6. The thermostable polymer electrolyte membrane of claim 4, wherein the monomer additionally comprises a polyfunctional monomer in an amount of 10% or less by weight on the basis of total monomer weight, wherein the polyfunctional monomer is selected from the group consisting of bis(vinylphenyl)ethane, divinylbenzene, 2,4,6-triallyloxy-1,3,5-triazine (triallyl cyanurate), triallyl-1,2,4-benzenetricarboxylate, diallylether, bis(vinylphenyl)methane, divinylether, 1,5-hexadiene and butadiene.

7. The thermostable polymer electrolyte membrane of claim 2, wherein the graft chain is prepared by radiation-induced graft-polymerization of styrene and divinylbenzene.

8. A process for producing a thermostable polymer electrolyte membrane comprising the steps of:
irradiating ionizing radiations to a base polymer comprising alicyclic polybenzimidazole,
contacting the irradiated base polymer with one or more monomers to graft the monomers by radiation-induced graft polymerization, and
sulfonating the graft chain introduced by the radiation-induced graft polymerization.

9. The process of claim 8, wherein the alicyclic polybenzimidazole polymer is represented by the following formula (I): 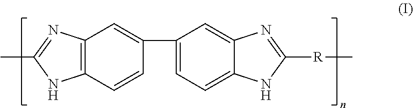
wherein R is C₃₋₂₀ cycloalkylene or C₇₋₁₄ spiroalkylene, n is an integer from 20 to 1000, and
the monomer is selected from the group consisting of aromatic vinyl compounds, acrylic acid or derivatives thereof, acrylamide derivatives, vinylketones, acrylonitriles and fluorinated vinyl compounds.

10. The process of claim 8, further comprising the steps of, for the preparation of the base polymer,
preparing a lyotropic liquid crystalline solution comprising alicyclic polybenzimidazole and lithium chloride, and
casting and drying the solution to a thin layer film.

11. The process of claim 8, wherein the sulfonating step comprises a step of contacting the base polymer with a sulfonating solution comprising a sulfonating agent of 0.005 to 0.1 mol/L at a temperature of 10° C. or below.

12. The process of claim 8, further comprising a step of, after the sulfonating step, heating the base polymer at 120 to 250° C. for 1 to 12 hours under vacuum, thereby imparting interchain multiple cross-linkages to the introduced graft chains.

13. A thermostable polymer electrolyte membrane produced by the process of claim 8, and having an ion exchange capacity (IEC) from 0.5 to 3.3 mmol/g, and a durability of 90% or more against hot water after incubation at 120° C. for 4 hours.

14. A fuel cell comprising the thermostable polymer electrolyte membrane of claim 1.
